(19) United States
(12) Patent Application Publication
(10) Pub. No.: US 2016/0096512 A1
(43) Pub. Date: Apr. 7, 2016

(54) WINDSCREEN WIPER, SYSTEM AND METHOD FOR WIPING A GLAZED MOTOR VEHICLE SURFACE

(71) Applicant: Valeo Systèmes d'Essuyage, Le Mesnil Saint Denis (FR)

(72) Inventors: Frédéric Giraud, Le Perray En Yvelines (FR); Denis Thebault, Clermont Ferrand (FR); Marcel Trebouet, Chavenay (FR)

(73) Assignee: Valeo Systèmes d'Essuyage, Le Mesnil Saint Denis (FR)

(21) Appl. No.: 14/873,272

(22) Filed: Oct. 2, 2015

(30) Foreign Application Priority Data
Oct. 2, 2014 (FR) 1459404

(51) Int. Cl. B60S 1/48

(52) U.S. Cl. CPC B60S 1/48

(57) ABSTRACT

The invention relates to a windscreen wiper for a system for wiping a glazed motor vehicle surface, intended to be driven pivot-wise by an actuation arm (3) of a wiping system (1), characterized in that it comprises at least one dedicated sprinkling orifice (8) configured to spray washing fluid (9) onto a predetermined zone (Z) of the glazed surface (2) behind which there is a sensor (10), said dedicated sprinkling orifice (8) being arranged in a portion of the windscreen wiper (P) sweeping said predetermined zone (Z) of the glazed surface (2) and forming a greater density of sprinkling orifices (5, 8) in said portion of the windscreen wiper (P) than over the rest of the windscreen wiper (4; 41) and/or having a greater opening section than the sprinkling orifices (5) situated outside of the predetermined zone (Z). The present invention relates also to a wiping system and a method for wiping a glazed motor vehicle surface.

The present invention relates to a windscreen wiper, a wiping system and a method for wiping a glazed motor vehicle surface.

Motor vehicles are commonly equipped with wiping installations and washing systems to ensure that the windscreen is wiped and washed and avoid having the vision of the driver of his or her surroundings disrupted. Such an installation generally comprises two wiper blades which scrape the outer surface of the windscreen so as to dispel the water present on this surface. The washing system comprises one or more nozzles, arranged in the cap or on the arms of the windscreen wipers, making it possible to spray a washing liquid onto the windscreen.

The vehicles are also being increasingly generally equipped with sensors which analyse the state of the windscreen or the state of the road. It can thus be a rain detector or a sensor of sunlight, of mist, of dirt or a signpost sensor. These sensors may comprise a photographic appliance or one or more cameras.

These sensors assist the driver in driving, for example by alerting the driver to hazards or by participating in the automatic triggering of a function of the vehicle (automatic warning of braking initiation, automatic triggering of the windscreen wipers if drops of water are seen on the windscreen, checking of certain headlight functions, etc.) or simply improve the visibility of the driver.

Such sensors are generally installed in an upper part of the windscreen. Their correct operation is conditional on the state of cleanliness of this zone of the windscreen. It is therefore necessary to proceed with an effective and regular cleaning of this zone.

One drawback is that the cap nozzle of the washing system is arranged far from the upper part of the windscreen. This means that the nozzle cannot spray enough windscreen washer liquid into the zone of the windscreen behind which the sensor is installed. Similarly, when the nozzles are arranged on the windscreen wiper arms, the latter can also not give full satisfaction, particularly at high speed, because the airstream tends to drive the windscreen washer liquid over the roof, thus preventing it from reaching the upper zone of the windscreen.

From this, it emerges that the cleaning of the zone of the windscreen behind which the sensor is placed cannot be ensured effectively enough, which can lead to sensor detection errors which can cause alerts or functions to be started up incorrectly.

The present invention sets out to at least partially remedy the abovementioned drawbacks by presenting a windscreen wiper, a wiping system and a method for wiping a vehicle window that makes it possible to particularly clean a zone of the windscreen behind which there is a sensor.

To this end, the subject of the invention is a windscreen wiper for a system for wiping a glazed motor vehicle surface, intended to be driven pivot-wise by an actuation arm of a wiping system, characterized in that it comprises at least one dedicated sprinkling orifice configured to spray washing fluid onto a predetermined zone of the glazed surface behind which there is a sensor, said dedicated sprinkling orifice being arranged in a portion of the windscreen wiper sweeping said predetermined zone of the glazed surface, and forming a greater density of sprinkling orifices in said portion of the windscreen wiper than over the rest of the windscreen wiper and/or having a greater opening section than the sprinkling orifices situated outside of the predetermined zone.

The predetermined zone of the glazed surface behind which the sensor is arranged can thus be cleaned effectively by the washing fluid sprayed by the dedicated sprinkling orifice(s). This enables the devices of the motor vehicle that use the data from the sensor, such as the advanced driver-assistance system software packages that use the images from cameras, to operate correctly. There is also an assurance that said predetermined zone is wiped after having been sprinkled.

According to one or more features of the windscreen wiper, taken alone or in combination:
the at least one dedicated sprinkling orifice is configured to spray a washing fluid onto said predetermined zone upstream and/or downstream of the windscreen wiper when the windscreen wiper is being driven pivot-wise,
the windscreen wiper blade has no sprinkling orifices outside of the at least one dedicated sprinkling orifice arranged in said portion of the windscreen wiper. The washing fluid is then sprayed only onto a portion of the windscreen, which makes it possible to save on the washing fluid. The dimensions of the tank and therefore the weight of the vehicle are thus reduced.
the windscreen wiper comprises at least one sprinkling boom comprising a plurality of sprinkling orifices extending along the longitudinal axis of the windscreen wiper, the dedicated sprinkling orifice being aligned with the sprinkling boom in said portion of the windscreen wiper sweeping said predetermined zone. A greater quantity of washing fluid is thus sprayed onto the predetermined zone than over the rest of the glazed surface during a sweep cycle.
the at least one dedicated sprinkling orifice arranged in said portion of the windscreen wiper sweeping said predetermined zone is situated on the side opposite the side of the windscreen wiper on which is formed at least one sprinkling orifice intended to spray washing fluid onto the glazed surface. With separate washing fluid channels for supplying, on the one hand, the dedicated sprinkling orifice(s) and, on the other hand, the orifices for sprinkling the glazed surface, it is possible to limit the quantity of washing fluid sprayed for the cleaning of the predetermined zone.

Another subject of the invention is a system for wiping a glazed motor vehicle surface, comprising at least one actuation arm intended to drive a windscreen wiper pivot-wise, a glazed surface and a sensor, characterized in that said actuation arm comprises at least one dedicated sprinkling orifice configured to spray a washing fluid onto a predetermined zone of the glazed surface behind which the sensor is arranged, the at least one dedicated sprinkling orifice being oriented so that the proximal part of the jet of sprayed washing fluid moves away from the longitudinal axis of the windscreen wiper by forming an angle greater than 2°, preferably than 3°.

The particular orientation of the dedicated sprinkling orifice thus makes it possible to maximize the quantity of fluid sprayed onto said predetermined zone, by targeting said zone when the actuation arm bearing the dedicated sprinkling orifice pivots closest to said zone.

According to one or more features of the wiping system taken alone or in combination,
the wiping system comprises a washing fluid control device configured to spray washing fluid through the at least dedicated sprinkling orifice according to the pivoting direction or the angular position of the windscreen wiper or of the actuation arm. There is thus a saving on the washing fluid, which makes it possible to reduce the dimensions of the tank and therefore the weight of the vehicle.
the wiping system comprises a windscreen wiper pivoting control device configured to drive at least one additional forward and backward sweep of the predetermined zone during a forward and backward sweep cycle of the glazed surface. This additional forward and backward sweep of the predetermined zone makes it possible to increase the quantity of washing fluid sprayed onto the predetermined zone of the glazed surface and its wiping compared to the rest of the glazed surface.

Yet another subject of the invention is a system for wiping a glazed motor vehicle surface, comprising at least one actuation arm, a glazed surface and a sensor, characterized in that it comprises a windscreen wiper as described previously, driven pivot-wise by the actuation arm.

According to one or more features of the wiping system taken alone or in combination,
the wiping system comprises a washing fluid control device configured to spray washing fluid through the at least one dedicated sprinkling orifice according to the pivoting direction or the angular position of the windscreen wiper or of the actuation arm.
the wiping system comprises a windscreen wiper pivoting control device configured to drive at least one additional forward and backward sweep of the predetermined zone during a forward and backward sweep cycle of the glazed surface.

Another subject of the invention is a method for wiping a glazed motor vehicle surface by a windscreen wiper, characterized in that a washing fluid is sprayed through at least one dedicated sprinkling orifice onto a predetermined zone of the glazed surface behind which there is a sensor from a wiping system as described previously.

According to one or more features of the wiping method taken alone or in combination,
the washing fluid is sprayed through the at least one dedicated sprinkling orifice only during a portion of the forward and backward sweep cycle of the glazed surface,
the washing fluid is sprayed through the at least one dedicated sprinkling orifice, only when the windscreen wipers sweep the predetermined zone,
the washing fluid is sprayed through the at least one dedicated sprinkling orifice only during upward or downward phases of the sweep,
a forward and backward sweep cycle of the glazed surface comprises at least one additional forward 30 and backward sweep of the predetermined zone,
during the forward and backward sweep cycle of the glazed surface, the washing fluid is sprayed through the at least one dedicated sprinkling orifice only on one side of the windscreen wiper in the upward phase and only on the opposite side in the downward phase, the at least one dedicated sprinkling orifice being arranged on the opposite side.

Other advantages and features will emerge from reading the description of the invention, and the attached drawings in which:

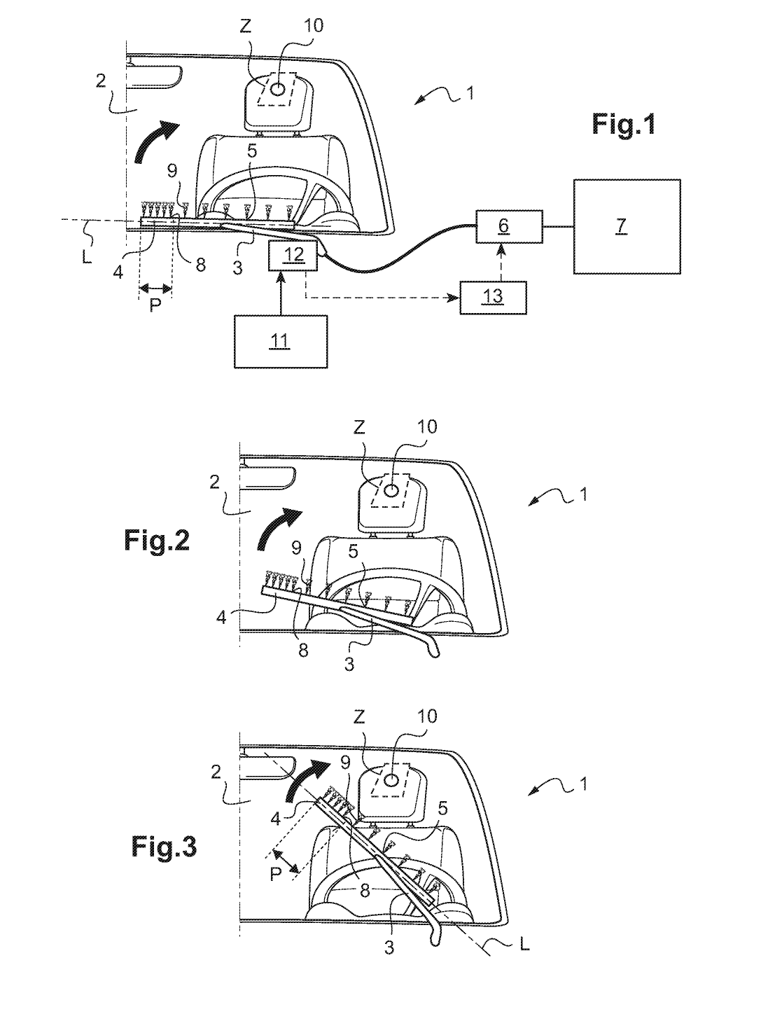

FIG. 1 represents a schematic view of a first exemplary embodiment of a system for wiping a glazed motor vehicle surface,

FIG. 2 illustrates a position of the windscreen wiper following FIG. 1 during a sweep of the glazed surface in the upward phase of the sweep,

FIG. 3 illustrates a position of the windscreen wiper following FIG. 2,

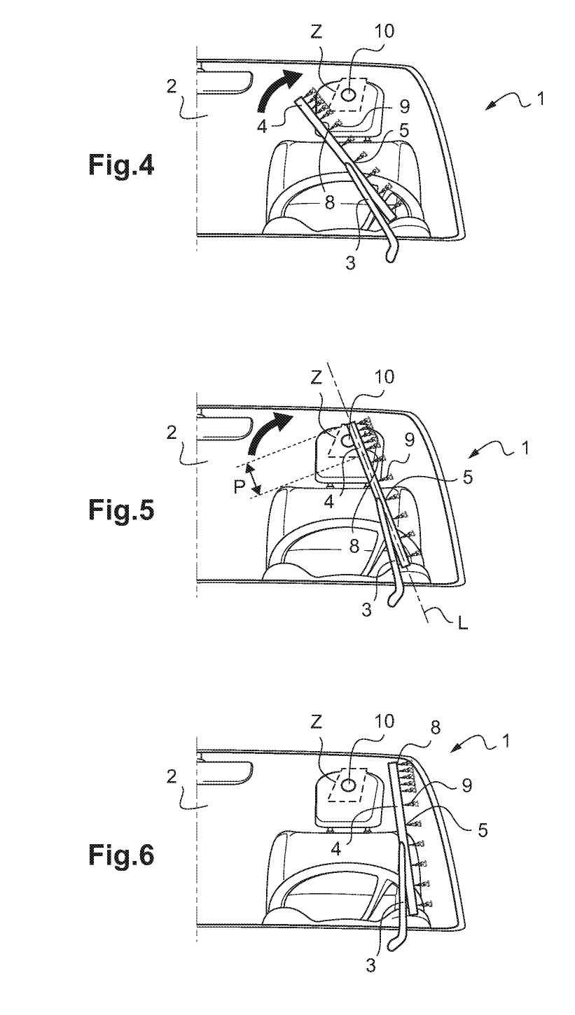

FIG. 4 illustrates a position of the windscreen wiper following FIG. 3,

FIG. 5 illustrates a position of the windscreen wiper following FIG. 4,

FIG. 6 illustrates a position of the windscreen wiper following FIG. 5,

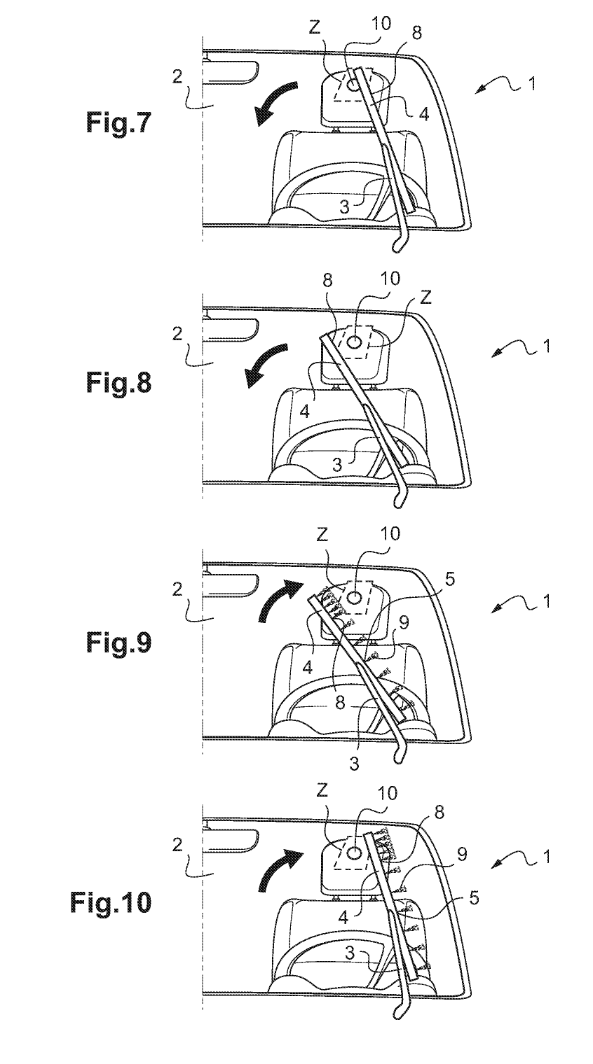

FIG. 7 illustrates a position of the windscreen wiper following FIG. 6 illustrating a variant embodiment of the wiping method,

FIG. 8 illustrates a position of the windscreen wiper following FIG. 7,

FIG. 9 illustrates a position of the windscreen wiper following FIG. 8,

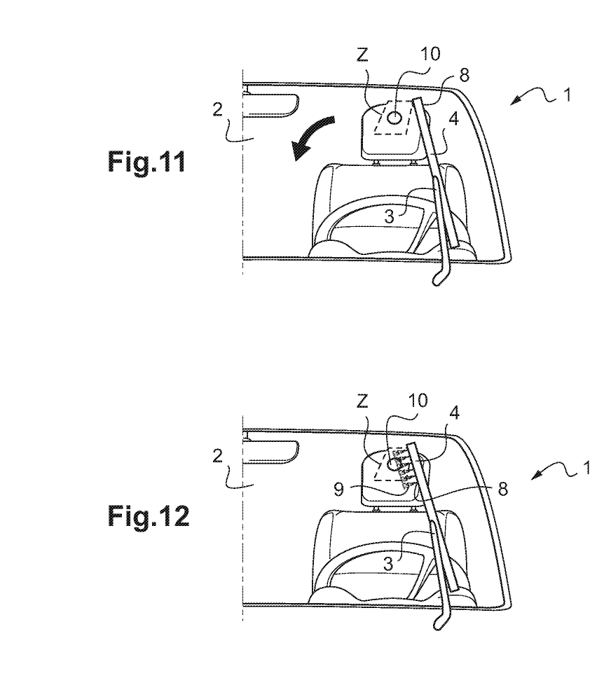

FIG. 10 illustrates a position of the windscreen wiper following FIG. 9,

FIG. 11 illustrates a position of the windscreen wiper during a sweep of the glazed surface in the downward phase of the sweep, according to another variant embodiment of the wiping method,

FIG. 12 illustrates a position of the windscreen wiper following FIG. 11,

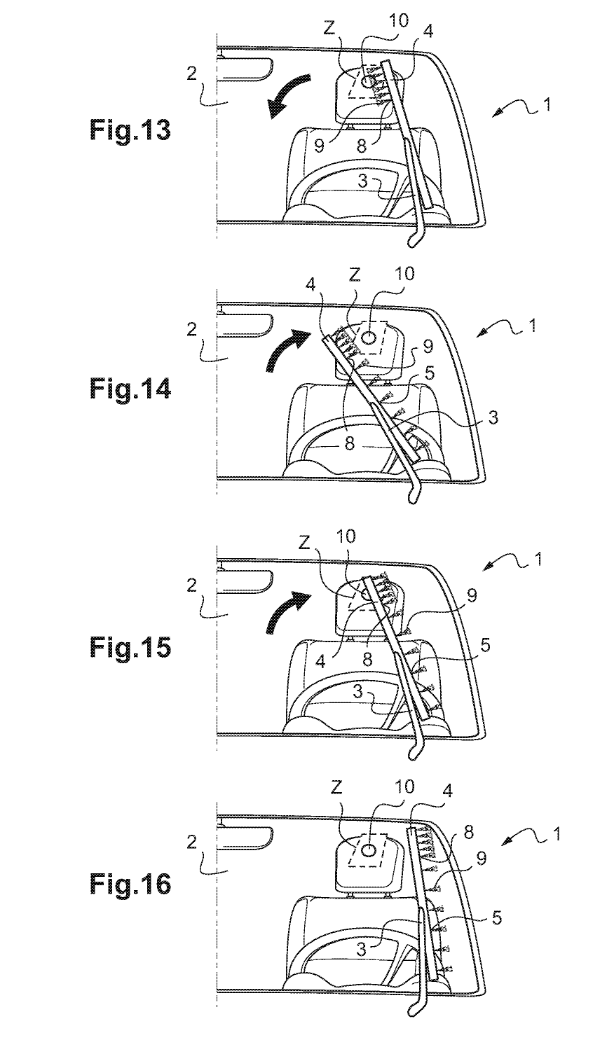

FIG. 13 illustrates a position of the windscreen wiper during a sweep of the glazed surface in the downward phase of the sweep, according to another variant embodiment of the wiping method,

FIG. 14 illustrates a position of the windscreen wiper following FIG. 13, in the upward phase,

FIG. 15 illustrates a position of the windscreen wiper following FIG. 14, in the upward phase,

FIG. 16 illustrates a position of the windscreen wiper following FIG. 15, in the upward phase,

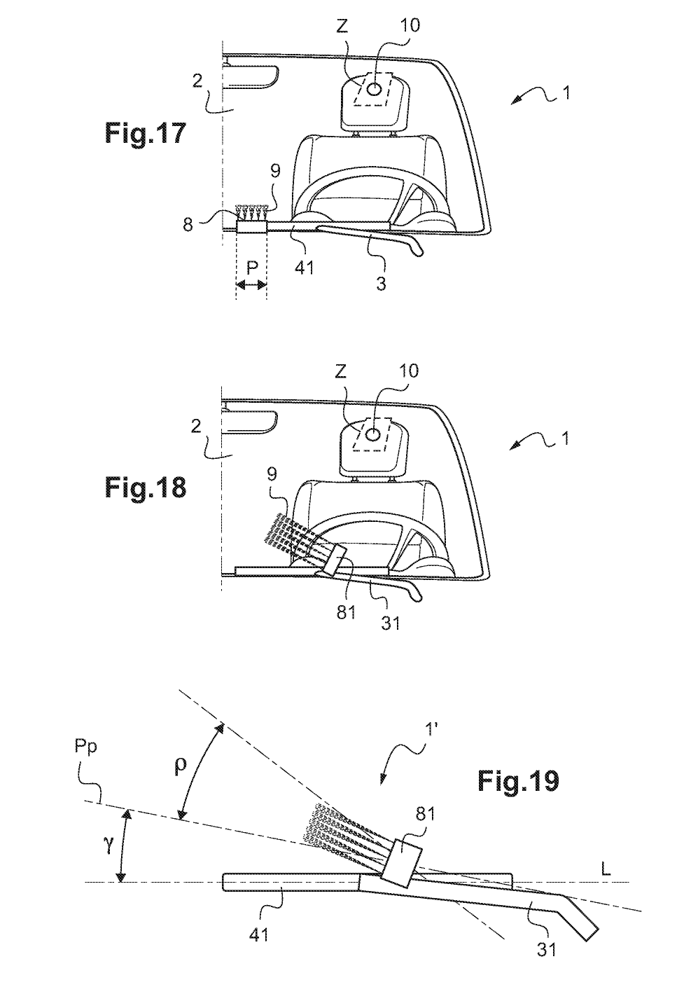

FIG. 17 represents a schematic view of another exemplary embodiment of a wiping system,

FIG. 18 represents a schematic view of another exemplary embodiment of a wiping system, and

FIG. 19 represents a schematic view of another exemplary embodiment of a wiping system.

In these figures, identical elements bear the same reference numbers.

FIG. 1 represents a system 1 for wiping a glazed surface 2 of a motor vehicle, such as the windscreen.

The wiping system 1 comprises at least one actuation arm 3 intended to drive a respective windscreen wiper 4 pivot-wise to scrape the outer surface of the glazed surface 2 according to a succession of forward and backward sweep cycles.

According to a first example that can be seen in FIG. 1, the windscreen wiper 4 comprises one or more sprinkling orifices 5 (or nozzles) configured to spray a washing fluid 9 onto the glazed surface 2. The blade 4 comprises, for example, one or two sprinkling booms respectively comprising a plurality of sprinkling orifices 5 extending along the longitudinal axis L of the windscreen wiper 4. The sprinkling orifices 5 are hydraulically coupled to a washing fluid pump 6 of the motor vehicle, which is in turn coupled to a tank 7.

The windscreen wiper 4 further comprises at least one dedicated sprinkling orifice 8 configured to spray washing fluid 9 onto the outer face of the glazed surface 2, on a predetermined zone of the glazed surface 2 behind which there is a sensor 10.

The predetermined zone Z is, for example, an upper part of the glazed surface 2 of the windscreen, on the driver side.

The sensor 10 is arranged behind the glazed surface 2, on the side inside the vehicle. It makes it possible to determine the state of the windscreen or the state of the road in front through the glazed surface 2. It can thus be a rain detector or a sensor of sunlight, of mist, of dirt or a signpost sensor. The sensor 10 comprises, for example, an optical sensor such as a photographic appliance or a camera whose lens is oriented towards the front of the vehicle.

The sensor 10 makes it possible, for example, to assist in the driving, for example by alerting the driver to hazards or by participating in the automatic triggering of a function of the vehicle (automatic warning of initiation of braking, automatic triggering of the windscreen wipers if drops of water are seen on the windscreen, checking of certain headlight functions, etc.) or simply improves the visibility of the driver.

The dedicated sprinkling orifice 8 is arranged in a portion of the windscreen wiper blade P sweeping the predetermined zone Z.

“Dedicated sprinkling orifice 8” should be understood to mean an orifice which increases the density of the sprinkling orifices in the portion of the windscreen wiper P sweeping the predetermined zone Z or an orifice which has an enlarged opening section compared to the sprinkling orifices 5 situated outside of the portion of the windscreen wiper P.

Thus, for example, if the separation of the orifices outside of the portion P is constant per unit of length, a dedicated sprinkling orifice 8 increases, at least locally in the portion of the windscreen wiper P, the number of orifices per unit of length.

According to another example, if no other sprinkling orifice 5 is formed in the blade outside of the portion P, at least one dedicated sprinkling orifice 8 formed in the portion increases, at least locally in the portion of the windscreen wiper P, the density of the orifices.

The windscreen wiper 4 can thus comprise one or more sprinkling orifice(s) 5, 8 in the portion of the windscreen wiper P and none, one or several sprinkling orifice(s) over the rest of the windscreen wiper 4. The density of sprinkling orifices 5, 8 is thus greater than over the rest of the windscreen wiper 4.

It is even possible for the windscreen wiper 4 to comprise at least one dedicated sprinkling orifice 8 arranged in the portion of the windscreen wiper P sweeping the predetermined zone Z, that has a greater opening section than that of the other sprinkling orifices 5.

Thus, if the number of sprinkling orifices per unit of length is, for example, constant over the length of the windscreen wiper 4, at least one of the orifices of the portion of the windscreen wiper P sweeping the predetermined zone Z has, compared to the sprinkling orifices 5 outside of the portion P, an enlarged diameter.

The predetermined zone Z of the glazed surface 2 behind which the sensor 10 is arranged can thus be cleaned effectively by the washing fluid 9 sprayed by the dedicated sprinkling orifice(s) 8. This makes it possible for the devices of the motor vehicle that use the data from the sensor 10, such as the advanced driver-assistance system software packages that use the images from cameras, to operate correctly. There is also an assurance that the predetermined zone Z is wiped after having been sprinkled.

In the first exemplary embodiment represented in FIGS. 1 to 6, the dedicated sprinkling orifice 8 is aligned with the sprinkling orifices 5 of the sprinkling boom.

When the windscreen wiper 4 is driven pivot-wise, the washing fluid 9 is thus sprayed through the dedicated sprinkling orifice onto the predetermined zone Z upstream and/or downstream of the windscreen wiper 4.

Provision is for example made for the washing fluid 9 to be sprayed in the same way by the sprinkling orifices 5 and the dedicated sprinkling orifice 8, in the upward phase and in the downward phase of the sweep. Thus, during the sweep, the washing fluid 9 is more specifically sprayed onto a predetermined zone Z of the glazed surface 2 behind which the sensor 10 is arranged.

FIGS. 7 to 10, following the end of the upward phase of the sweep illustrated in FIG. 6, represent a first variant embodiment of the wiping method.

In this variant, the wiping system 1 comprises a windscreen wiper pivoting control device 11, configured to drive the motor 12 of the actuation arms 3 to perform at least one additional forward and backward sweep of the predetermined zone Z, during the forward and backward sweep cycle.

This additional forward and backward sweep of the predetermined zone Z makes it possible to increase the quantity of washing fluid 9 sprayed onto the predetermined zone Z of the glazed surface 2 and its wiping compared to the rest of the glazed surface 2.

To reduce the consumption of washing fluid 9, provision can be made for the wiping system 1 to comprise a washing fluid control device 13, configured to control the triggering of the washing fluid pump 6 so as to spray washing fluid 9 through the dedicated sprinkling orifice 8 according to the pivoting direction or the angular position of the windscreen wiper 4 or of the actuation arm 3. The washing fluid 9 specifically sprayed onto the predetermined zone Z can thus be sprayed only during a portion of a forward and backward sweep cycle of the glazed surface 2.

For example, provision is made for the washing fluid 9 to only be sprayed through the dedicated sprinkling orifice 8 during upward phases of the sweep (FIGS. 9 and 10). The washing fluid is not sprayed through the dedicated sprinkling orifice 8 during downward phases of the sweep (FIGS. 7 and 8). There is thus a saving on the washing fluid, which makes it possible to reduce the dimensions of the tank 7 and therefore the weight of the vehicle.

Conversely, provision can be made for the washing fluid 9 to only be sprayed through the dedicated sprinkling orifice 8 during downward phases of the sweep.

According to another example illustrated in FIGS. 11 and 12, which represent two successive positions of the windscreen wiper 4 in the downward phase of the sweep, the washing fluid 9 is sprayed through the dedicated sprinkling orifice 8 only when the windscreen wipers 4 sweep the predetermined zone Z, that is to say when they pass over the zone of the glazed surface 2 behind which the sensor 10 is arranged (FIG. 12). The washing fluid 9 is not sprayed through the dedicated sprinkling orifice 8 when the windscreen wiper is situated outside of the predetermined zone Z (FIG. 11).

According to another variant embodiment illustrated by FIGS. 13 to 16, the dedicated sprinkling orifice 8 is arranged in the portion of the windscreen wiper P sweeping the predetermined zone Z, on the side opposite the side of the windscreen wiper 4 on which is formed at least one sprinkling orifice 5 intended to spray washing fluid 9 onto the glazed surface 2.

The dedicated sprinkling orifice 8 is hydraulically coupled to the washing fluid pump 6, for example with pipes independent from those supplying washing fluid to the sprinkling orifice or orifices 5 of the glazed surface 2. The dedicated sprinkling orifice 8 and the sprinkling orifices 5 of the glazed surface 2 are thus arranged to spray the washing fluid respectively on either side of the longitudinal axis L of the wiping blade 4.

The density of sprinkling orifices 5, 8 is then greater in the portion P of the windscreen wiper 4 sweeping the predetermined zone Z than over the rest of the windscreen wiper 4.

Thus, during the sweep, the washing fluid 9 can be sprayed only on the front side of the windscreen wiper 4 in the upward phase of the sweep (FIGS. 14, 15, 16). Then, in the downward phase, the washing fluid 9 is sprayed only on the front side of the windscreen wiper 4 through the dedicated sprinkling orifice 8, 35 that is to say on the opposite side, specifically onto the predetermined zone Z (FIG. 13).

The dissymmetry between the sprinkling orifice 5 (or sprinkling boom) on one side of the blade 4 and the dedicated sprinkling orifice 8 on the other side makes it possible for a greater quantity of washing fluid 9 to be sprayed onto the predetermined zone Z than onto the rest of the glazed surface 2 during a forward and backward sweep cycle of the glazed surface 2. Furthermore, the consumption of washing fluid 9 is limited. According to another exemplary embodiment of the blade represented in FIG. 17, the windscreen wiper 41 comprises no sprinkling orifices other than those of the dedicated sprinkling orifice 8, arranged in the portion of the windscreen wiper P intended to sweep the predetermined zone Z. It thus has no sprinkling orifices outside of the dedicated sprinkling orifice 8 arranged in the portion of the blade P. The washing fluid 9 is then sprayed only onto a portion of the windscreen, which makes it possible to save on the washing fluid 9. The dimensions of the tank and therefore the weight of the vehicle are thus reduced.

Instead of being arranged in the windscreen wiper 4, the dedicated sprinkling orifice 81, configured to spray a washing fluid onto the predetermined zone Z, can be arranged in the actuation arm 31. The dedicated sprinkling orifice 81 is, for example, directly incorporated in the actuation arm 31, by being, for example, formed in the body of the actuation arm 31 or can be arranged in an added element distinct from the arm, the added element being fixed to the body of the actuation arm 31.

In this case, and as represented in FIGS. 18 and 19, the at least one dedicated sprinkling orifice 81 is oriented for the part Pp proximal to the windscreen wiper 4 of the sprayed jet of washing fluid 9 to move away from the longitudinal axis L of the windscreen wiper 4 by forming an angle γ greater than 2°, preferably than 3°. Furthermore, provision is made for the jet of washing fluid 9 to be inscribed, for example, in a cone with a summit angle ρ of the order of 42° maximum.

In use, the dedicated sprinkling orifice 81 sprays a washing fluid 9 upstream and/or downstream of the windscreen wiper 41.

The particular orientation of the dedicated sprinkling orifice 81 thus makes it possible to maximize the quantity of washing fluid 9 sprayed onto the predetermined zone Z, by targeting the zone Z when the actuation arm 31 bearing the dedicated sprinkling orifice 81 pivots closest to the zone Z.

1. A windscreen wiper for a system for wiping a glazed motor vehicle surface, configured to be driven pivot-wise by an actuation arm of a wiping system, the wiper comprising:
at least one dedicated sprinkling orifice configured to spray washing fluid onto a predetermined zone of the glazed surface behind which there is a sensor,
said dedicated sprinkling orifice being arranged in a portion of the windscreen wiper sweeping said predetermined zone of the glazed surface, and forming a greater density of sprinkling orifices in said portion of the windscreen wiper WPM than over the rest of the windscreen wiper and/or having a greater opening section than the sprinkling orifices situated outside of the predetermined zone.

2. The windscreen wiper according to claim 1,
wherein the at least one dedicated sprinkling orifice is configured to spray a washing fluid onto said predetermined zone upstream and/or downstream of the windscreen wiper when the windscreen wiper is being driven pivot-wise.

3. The windscreen wiper according to claim 1, wherein the wiper lacks sprinkling orifices outside of the at least one dedicated sprinkling orifice arranged in said portion of the windscreen wiper.

4. The UM/windscreen wiper according to claim 1, wherein it comprises at least one sprinkling boom comprising a plurality of sprinkling orifices extending along the longitudinal axis of the windscreen wiper, the dedicated sprinkling orifice being aligned with the sprinkling boom in said portion of the windscreen wiper sweeping said predetermined zone.

5. The windscreen wiper according to claim 1, wherein the at least one dedicated sprinkling orifice arranged in said portion of the windscreen wiper sweeping said predetermined zone is situated on the side opposite the side of the windscreen wiper on which is formed at least one sprinkling orifice intended to spray washing fluid onto the glazed surface.

6. A system for wiping a glazed motor vehicle surface, comprising:
at least one actuation arm intended to drive a windscreen wiper pivot-wise;
a glazed surface; and
a sensor said actuation arm comprises at least one dedicated sprinkling orifice configured to spray a washing fluid onto a predetermined zone of the glazed surface behind which the sensor is arranged, the at least one dedicated sprinkling orifice being oriented so that the proximal part of the jet of sprayed washing fluid moves away from the longitudinal axis of the windscreen wiper by forming an angle greater than 2°, preferably than 3°.

7. A system for wiping a glazed motor vehicle surface, comprising:
at least one actuation arm;
a glazed surface;
a sensor; and
a windscreen wiper according to claim 1 driven pivot-wise by the actuation arm.

8. The wiping system according to claim 7, further comprising a washing fluid control device configured to spray washing fluid through the at least one dedicated sprinkling orifice according to the pivoting direction or the angular position of the windscreen wiper or of the actuation arm.

9. The wiping system according to claim 7, further comprising a windscreen wiper pivoting control device configured to drive at least one additional forward and backward sweep of the predetermined zone during a forward and backward sweep cycle of the glazed surface.

10. A method for wiping a glazed motor vehicle surface by a windscreen wiper, comprising
spraying a washing fluid through at least one dedicated sprinkling orifice onto a predetermined zone of the glazed surface behind which there is a sensor from a wiping system according to claim 6.

11. The wiping method according to claim 10, wherein the washing fluid is sprayed through the at least one dedicated sprinkling orifice only during a portion of the forward and backward sweep cycle of the glazed surface.

12. The wiping method according to claim 11, wherein the washing fluid is sprayed through the at least one dedicated sprinkling orifice, only when the windscreen wipers sweep the predetermined zone.

13. The wiping method according to claim 11, wherein the washing fluid is sprayed through the at least one dedicated sprinkling orifice only during upward or downward phases of the sweep.

14. The wiping method according to claim 10, wherein a forward and backward sweep cycle of the glazed surface comprises at least one additional forward and backward sweep of the predetermined zone.

15. The wiping method according to claim 10, wherein during the forward and backward sweep cycle of the glazed surface, the washing fluid is sprayed through the at least one dedicated sprinkling orifice only on one side of the windscreen wiper in the upward phase and only on the opposite side in the downward phase, the at least one dedicated sprinkling orifice being arranged on the opposite side.
